(19) United States
(12) Patent Application Publication
(10) Pub. No.: US 2021/0402529 A1
(43) Pub. Date: Dec. 30, 2021

(54) METHOD OF HYPER-FEED MACHINING TURBOMACHINE BLADED COMPONENTS

(71) Applicant: Tennine Corp., Grand Rapids, MI (US)

(72) Inventors: William Q. Tingley, Grand Rapids, MI (US); William Q. Tingley, III, Grand Rapids, MI (US); Daniel R. Bradley, Grand Rapids, MI (US)

(21) Appl. No.: 17/119,087

(22) Filed: Dec. 11, 2020

Related U.S. Application Data
(63) Continuation-in-part of application No. 16/667,325, filed on Oct. 29, 2019.
(60) Provisional application No. 62/754,741, filed on Nov. 2, 2018.

(51) Int. Cl. B23P 15/02

(52) U.S. Cl. CPC B23P 15/02; F01D 5/14

(57) ABSTRACT

A method of hyper-feed machining the bladed components of turbomachines, and more specifically their bladed components. Hyper-feed machining, by means of the physical process of controlled fracturing, is the fastest, most precise, and nearest net shape method of machining in existence. The practical effects of the invention are: (1) the production of new and useful small-scale gas turbine engines for a wide range of previously impossible or impractical applications, and (2) the production of existing larger-scale gas turbine engines with great improvements in material removal rates by orders of magnitude, greater precision and geometric complexity of the bladed components, faster overall rates of production of these engines, and significantly reduced costs in production. As a consequence, the best preferred embodiment of the invention is the small-scale turboshaft electric engine for automotive vehicles, which makes possible a turbo-electric vehicle that replaces both the electric battery vehicle and the piston-engine vehicle.

### FIELD OF THE INVENTION

The invention pertains to the manufacturing of turbomachines. Specifically, it is the hyper-feed machining of the bladed components of a turbomachine. Hyper-feed machining, by means of the physical process of controlled fracture, is the fastest, most precise, and nearest net shape method of machining in existence. The invention encompasses all types of turbomachines, but is particularly effective in the production of gas turbine engines. Therefore, all references to gas turbine engines herein do not exclude any other type of turbomachine.

Hyper-feed machining is an entirely new method of producing gas turbine engines. More information regarding the process of controlled fracture is fully described in Applicant's U.S. Pat. No. 9,101,991 entitled Method and Apparatus for Non-Spindle Multi-Axis Machining assigned to Tennine Corp. and incorporated by reference herein in its entirety. Manufacturing the bladed components of gas turbine engines by hyper-feed machining is orders of magnitude greater in volumetric removal rates over all other methods of manufacture. It is more precise and more accurate. It can produce components with blades that are more geometrically complex, more highly curved, and thinner in cross-section. Most significantly, it can machine bladed components that are smaller in scale than current turbomachines of all kinds. This makes possible and practical the production of gas turbine engines for a new world of applications replacing all manner of more complex, high-emission, and more expensive engines for propulsion and power generation, in particular electric battery and piston engines.

By applying hyper-feed machining to the manufacture of gas turbine engines, two fundamentally significant advances in their production are made possible and practical. The first advance is the full scalability of this method in the manufacture of the bladed components of gas turbine engines. With hyper-feed machining, these small-scale gas turbine engines are both high performance and as efficient as their larger scale counterparts. These engines, made possible by the invention, are new and useful. New applications include: (1) turbo-electric vehicles, replacing both electric battery vehicles and piston engine vehicles; (2) turboshaft electric helicopters and VSTOL aircraft; (3) small turbo-electric aircraft, drones, and marine vessels; (4) military vehicles with attritable engines; (5) household turbo-electric power generators; and many other new uses.

The second advance is the great improvement in the manufacture of the bladed components of all existing larger-scale gas turbine engines over current state-of-the-art methods, including milling, forming, and casting. These improvements include: (1) Rates of material removal at higher orders of magnitude, (2) greater geometric complexity and precision in design and net-shape machining of the blades, (3) cross-sections that are thinner and stronger than current methods permit, and (4) the greatly reduced cost of producing these bladed components and gas turbine engines overall. Any single one of these improvements, now possible with the invention, is new and useful to the industry.

### BACKGROUND OF THE INVENTION

### Gas Turbine Engines

Gas turbine engines are relatively simple machines. The basic components include a housing, an intake, a compressor or plurality of them, a combustion chamber, at least one turbine, and a turbine-driven shaft. The bladed components are the compressor and the turbine. Sometimes there are other bladed components including stators and impellors. The difficulty in producing gas turbine engines is the manufacture of these bladed components. This is because of the geometric complexity of their blades, which must be highly curved for effective operation of a gas turbine engine. Ideally these components are in the form of a “blisk”, in which the blades and their base constitute a single unit. As used herein, the term blisk means a gas turbine engine component comprising both a rotor disk and a plurality of curved blades projecting orthogonally from the circumference of the disk.

### Machining Processes

Computer numerical-controlled milling of gas turbine engine blisks is the most common current method. A ball-nose end mill is typically the cutting tool used. The ball-nose must spin on its axis to produce sufficient torque to cut away material from the workpiece to an approximation of the net shape. By its nature this imposes axial symmetry upon the ball-nose as a cutting tool. This significantly restricts the shapes that a ball-nose can cut into a workpiece to manufacture a blisk, especially its blades. The ball-nose's axial symmetry also frequently creates interference problems with the compound curves of the blades, which results in the ball-nose cutting away previously machined portions of the blades to reach deeper surfaces that need to be machined; therefore, not capable of cutting those surfaces at all.

Furthermore, milling by rotating a cutting tool requires fluting the ball-nose with a plurality of cutting edges. When the ball-nose is spun to produce torque as the force to remove material from the workpiece to approximate net shape, these flutes rotate in and out of the workpiece. Thus, the cut is not continuous but interrupted. This significantly restricts the performance of the ball-nose, especially in terms of the rate of volumetric material removal from the workpiece to produce a blisk. Moreover, this discontinuous plastic deformation of the workpiece imparts heat to it which makes the milling of thin cross-sections imprecise or prone to fracture from embrittlement.

### SUMMARY OF THE INVENTION

Overcoming the limitations of even the best state-of-the-art milling method, the invention fundamentally alters the manner of material removal from the workpiece to produce a precision net-shape blisk by means of hyper-feed machining. The difference is that, unlike milling, hyper-feed machining does not use torque as a force to remove material from the workpiece. Instead, it uses only linear force. As a consequence material is removed by cutting tools that move extremely fast through the workpiece. Furthermore, the linear force of hyper-feed machining does not impose symmetry upon its cutting tools. These tools can be offset, dog-boned, or otherwise shaped to permit their cutting edges to reach deep or partially blocked surfaces that are impossible to machine by current milling methods. Together, these and other advantages of the hyper-feed machining method of producing the bladed components of a gas turbine engine make possible the first and second advances described above, which are currently impossible or impractical with current state-of-the-art methods.

### BRIEF DESCRIPTION OF THE DRAWINGS

The accompanying figures where like reference numerals refer to identical or functionally similar elements throughout the separate views and which together with the detailed descriptions below are incorporated in and form part of the specification, serve to further illustrate various embodiments and to explain various principles and advantages all in accordance with the present invention.

FIG. 1 is a diagram of the basic components and their arrangement for a gas turbine engine.

FIG. 2 is a diagram of the basic components and their arrangement for a gas turbine engine configured as a jet engine.

FIG. 3 is a diagram of the basic components and their arrangement for a gas turbine engine configured as a turboshaft engine driving a device for either power generation or transmission for propulsion.

FIG. 4A, FIG. 4B and FIG. 4C are examples of a small complex blisk employed as a high-efficiency compressor or turbine, the geometry of which permits only the use of hyper-feed machining for rapid, precise, and net shape production of it. Illustrated are a plan view in FIG. 4A, an elevation view in FIG. 4B, and an isometric view in FIG. 4C.

FIG. 5A, FIG. 5B, FIG. 5C, FIG. 5D, FIG. 5E, and FIG. 5F illustrate the in-process hyper-feed machining of a blisk fixtured on a 5-axis machine tool.

FIG. 6 is a flow chart diagram illustrating the process of hyper-feed machining turbomachine components such as blisks and the like.

Skilled artisans will recognize that the figures illustrate the invention's elements, including its principles, elements, embodiments, and advantages, for simplicity and clarity. Therefore skilled artisans will also recognize that these elements are not necessarily to scale, may be exaggerated, and are not intended as mechanical drawings or other such production documents.

### DETAILED DESCRIPTION

### Introduction

Before describing in detail the embodiments that are in accordance with the present invention, it should be observed that the embodiments reside primarily in combinations of the method of hyper-feed machining and the apparatus of a gas turbine engine's bladed components. Accordingly, the method and apparatus have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

### The Hyper-Feed Machining Method

The invention's use of linear force to remove material from the workpiece is the physical process of controlled fracturing. It occurs by applying an impact force that simultaneously exceeds the yield strength and the breaking strength of the workpiece material to initiate controlled fracturing instead of plastic deformation to remove material. The material used in methods and processes described herein is a metal and/or other materials having similar machining characteristics. The present invention can also be used to machine materials in which controlled fracture cannot be induced, such as plastic and carbon-fiber, but the material removal occurs by the process of plastic deformation instead of controlled fracture. Instead a controlled-fracture impact causes an axial projection of adiabatic banding of micro-cracks along the perimeter of the cutting tool to produce a repeatable, precise removal of workpiece material. Hyper-feed machining is the method of using the physical process of controlled fracture to the machining of workpieces. The result is the fastest, most precise, and nearest net shape method of machining in existence.

The application of hyper-feed machining to the bladed components of a gas turbine engine is new and useful, as evidenced in particular by the new capability to manufacture small-scale gas turbine engines of all types as described above in the invention's first fundamental advance. Among these newly available small-scale gas turbine engines, the most preferred embodiment is the turbo-electric automotive vehicle that would replace both the electric battery vehicle and the piston engine vehicle. The process of controlled fracture machining is further described in U.S. patent application Ser. No. 16/835,186 entitled Controlled Fracture Machining Method For Producing Through-Holes, filed Mar. 30, 2020 and assigned to Tennine Corp. which is also herein incorporated by reference in its entirety.

The invention's second fundamental advance in the manufacture of current gas turbine engines in production also has new and useful improvements, including: (1) greater geometric complexity of the bladed components for improved performance, (2) greater precision in machining to net shape, (3) greater precision and less distortion in machining thin cross-sections making possible greater reduction in the blisk's mass, thus lowering the pressure needed to rotate the bladed components, and (4) greater ease of production reducing the cost and time of manufacture while improving precision and dimensional accuracy, among other things. The invention makes possible both of these fundamental advances in the production of gas turbine engines without any compromises.

Hyper-feed machining overcomes the inherent limitations in the current use of computer numerical-controlled milling of the compressor 101, 202, 301 and turbine 103, 204, 303, 305 components of a gas turbine 100, 200, 300, especially when those components are in the favored form of a blisk 400. Hyper-feed machining does not rely upon torque as a cutting force. The cutting tool 504 is driven strictly by linear forces through the blisk workpiece 500, 501, 502, 503 to machine to net shape its geometrically complex surface 402 of blades 401 integrated with the blisk's base 403.

Thus, the invention's method of hyper-feed machining produces the desired net shape in the workpiece by using controlled fracturing to induce an abrupt, highly localized, and substantially extreme force of a cutting tool 504 against the workpiece 500, 501, 502, 503. This force must be sufficient to exceed simultaneously the yield strength and the breaking strength of the material of the workpiece. When the force is applied, adiabatic shear bands form in the workpiece as a microstructure of micro-cracks emanating in the direction of the cutting tool 504 within the outside contour 505 of the cutting tool as projected into the workpiece 500, 501, 502, 503. Under the continued force of the cutting tool moving through the workpiece, this microstructure softens relative to the uncut material surrounding it, because the cracked material becomes highly fractured, even to the point of recrystallizing. Once softened the cutting tool shears this material from the workpiece as waste which retains almost all of the heat generated by the process, because its microstructure of cracks retards the transfer of heat to material outside of the microstructure. The end result of this controlled fracture process is a shape 402 cut into the workpiece 500, 501, 502, 503 with the same contour 505 as the cutting tool 504.

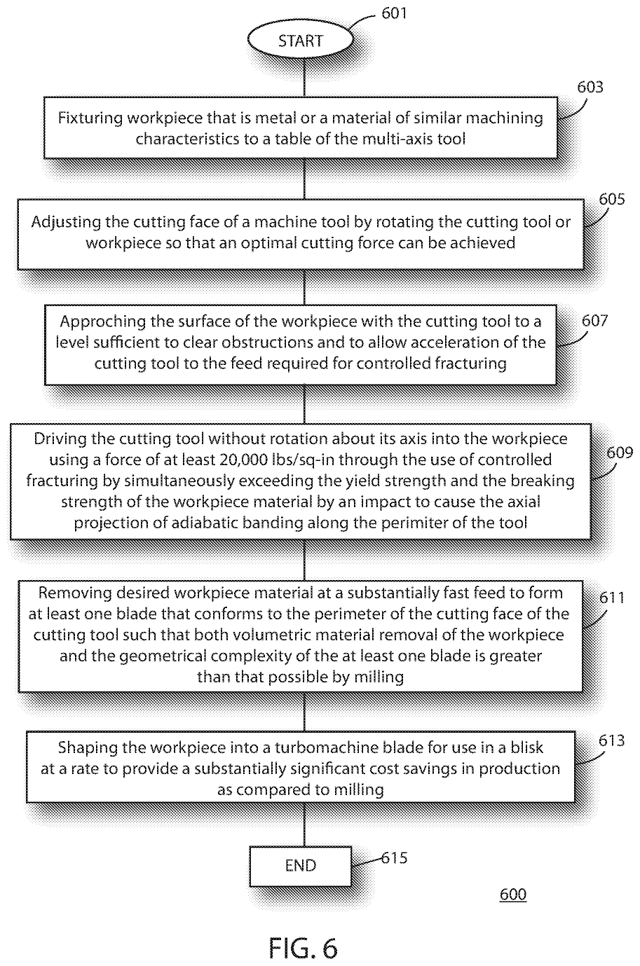

FIG. 6 is a flow chart diagram illustrating the process of hyper-feed machining turbomachine components such as blisks and the like. The method of hyper-machining turbomachine components is a process 600 that includes a series of steps needed to achieve a precision shape for turbomachine components. The process starts 601 by fixturing a metal or metal-like blisk workpiece to a table of the multi-axis machine tool 603; adjusting the cutting face of a machine tool by linearly and/or axially changing the orientation the cutting tool or workpiece to the other so that an optimal cutting force can be achieved 605; approaching the surface of the workpiece with the cutting tool to a level sufficient to clear obstructions and to allow acceleration of the cutting tool to the speed required to induce controlled fracturing 607; driving the cutting tool without rotation about its axis into the workpiece using a force of at least 20,000 lbs/sq-in through the use of controlled fracturing in which the yield strength and the breaking strength of the workpiece material are simultaneously exceeded at impact 609; causing the axial projection of banding along the perimeter of the tool while it is driven along a pre-determined tool path though the workpiece; removing the desired amount of workpiece material 611 to form and shape 613 at least one blade of a blisk in conformity to the perimeter of the cutting face of the cutting tool; withdrawing the cuffing tool from the workpiece to a predetermined level; resetting the cutting tool using the drive mechanism; then repeating the step of removing desired work piece material; and finally, retracting the cutting tool from a work envelope when a desired blisk net shape has been achieved where the process ends 615.

Employing linear force by means of hyper-feed machining eliminates restrictions on the shape and size of the cutting tool 504 so that its cutting edge 505 can more closely conform to the ideal design 402 of the bladed components. This also keeps the cutting tool continuously in cut as it is driven through the blisk workpiece 500 501 502 503 and increases the rate of volumetric material removal by orders of magnitude over current methods of machining. For example, the blisk 400 may have a 6-inch diameter base 403 with compound-curved blades 401 that are 0.030-inch thick and separated by a 0.100- to 0.141-inch tapered gap 402. Those skilled in the art will recognize that the dimensions of this example do not indicate any restrictions in the size and complexity of the blisks that can be machined by controlled fracturing. Blisks configured from one-tenth to ten times the size of the example, and beyond, can be machined under the same principles, because this method of production is fully scalable.

With the blisk fixtured 507 on a five-axis hyper-feed machining center 506, for example, the blisk workpiece 400 can be presented at any angle and orientation that maximizes the performance of the cutting tool 504. Volumetric material removal rates of hyper-feed machining are one or more orders of magnitude greater than the most advanced current milling methods. Typical of this performance on a blisk is moving a 0.100-inch wide cutting tool through the blisk workpiece 500 501 502 503 at a feed rate of at least 1,200 inches a minute, thus completing the blisk 400 to a precision, finely finished, net shape surface 402 in about 10 minutes time. This compares to several hours or more work using current milling methods with less precision and greater departures from net shape for the blisk, assuming that current methods can even machine the complex surfaces required of blisk blades.

### New and Useful Embodiments of the Invention

Those skilled in the art will recognize that the invention makes possible the greater geometric complexity in the design of a bladed component's 400 surface 402 to improve the performance of a turbomachine, especially the gas turbine 100, 200, 300. The complexity is one of compound curves, often curve on curve on curve, in which the blades 401 of a compressor 101, 202, 301 or a turbine 103, 204, 303, 305 are folded over themselves or even over the neighboring blade. This complexity provides a greater surface area over a volume of fluid flow so that a flow pressure, lower than that needed to turn the bladed components of existing gas turbine engines, is sufficient for operation of new ones made possible by the invention. Like scalability, this greater geometric complexity is possible because of the hyper-feed machining feature of the invention and its employment of linear-force driven 500, 501, 502, 503 asymmetrical cutting tools 504 that can be shaped with the cutting edges 505 and clearances needed to precisely machine, without clearance problems or interference with previously machined surfaces, to net shape 402 curve on curve on curve folded blades 401 of a compressor 101, 202, 301, a turbine 103, 204, 303, 305, or other bladed component of a gas turbine engine. Those skilled in the art will also recognize that hyper-feed machining's use of linear force, as opposed to conventional milling's use of torque, provides sufficient force to remove material from the workpiece 500, 501, 502, 503.

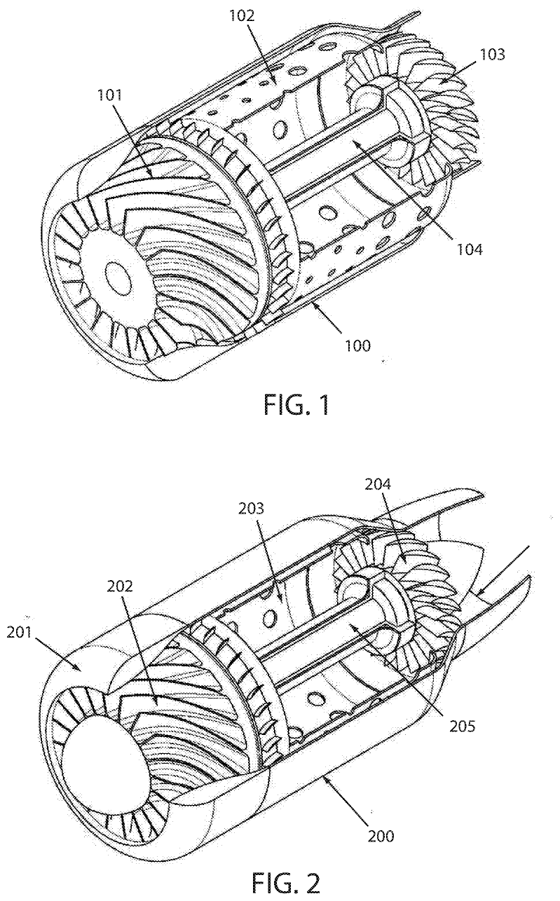

FIG. 1 is a diagram of the basic components and their arrangement for a gas turbine engine. All gas turbine engines 100 have at least four components: (1) An upstream compressor 101, (2) a downstream turbine 103 (in the industry “turbine” is a term of art for both entire gas turbine assembly 100 and this torque-producing component 103), (3) a shaft 104 which attaches the turbine to the compressor so that the rotation of the turbine drives the compressor, and (4) a combustor 102 between the compressor and the turbine.

A gas turbine engine 100 operates as follows: (1) The fluid flows into the compressor 101, (2) the compressor compresses the flow, which increases its velocity, (3) the compressed flow enters the combustor 102 which heats and adds energy to the flow, (4) the flow exits the combustor to turn the turbine 103, (5) the turbine turns to drive the compressor by means of the shaft 104 connecting them, and (6) the flow exits the turbine through a nozzle 206, in the simplest form of a gas turbine engine, as a jet to provide propulsion, or to drive a device 307 either for power generation or for transmission for propulsion.

FIG. 2 is a diagram of the basic components and their arrangement for a gas turbine engine configured as a jet engine. As seen in FIG. 2, a functioning basic jet engine 200 consists of an intake 201, a compressor 202, a combustor 203, a turbine 204, a shaft 205 connecting the compressor to the turbine, and a nozzle 206. One or more of the bladed components, the intake, the compressor, or the turbine, is manufactured by hyper-feed machining in the form of a bladed ring for the intake and a blisk for the compressor and the turbine. The hyper-feed machining feature of the invention enables it to be embodied as a small-scale jet engine to propel marine vessels and aircraft that are too small for the weight and size of current jet engines. This includes surface and subsurface waterjet vessels, small aircraft, vertical take-off and landing aircraft, helicopters, and drones, and is especially effective for military aircraft requiring attritable propulsion systems, all at low cost, great precision, and fast rates of production. Also, hyper-feed machining enables the production of bladed components with sufficient geometric complexity and reduced mass to exploit lower pressure flows of fluid for the small-scale applications of the invention as a jet engine.

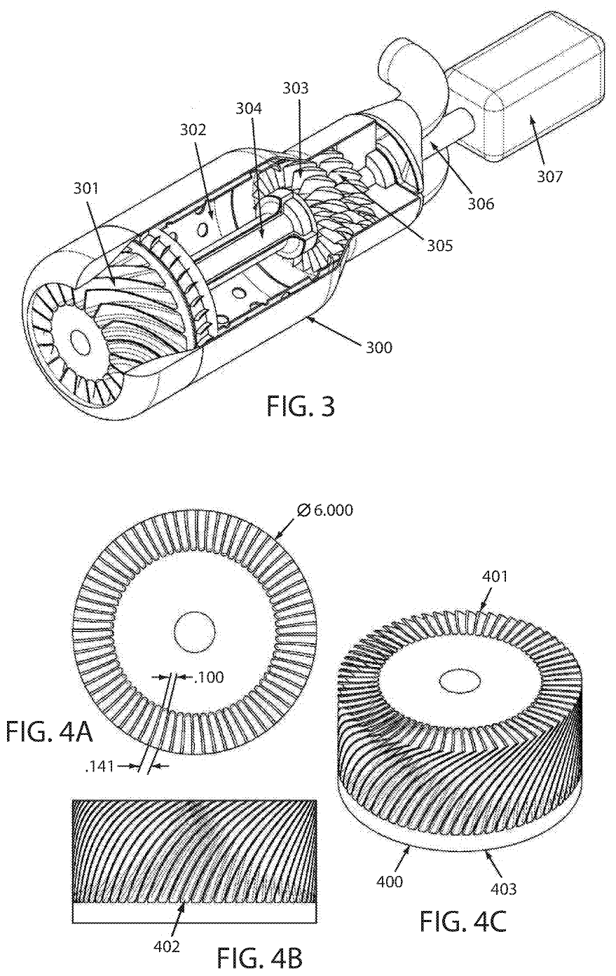

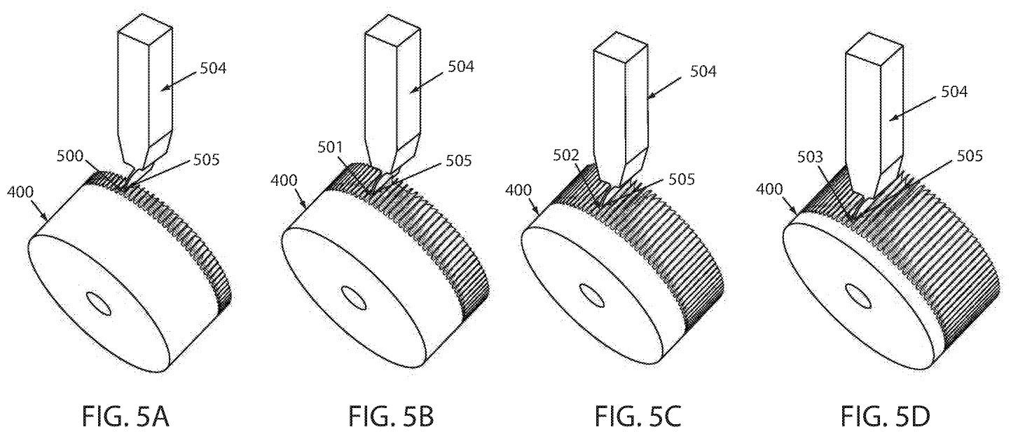

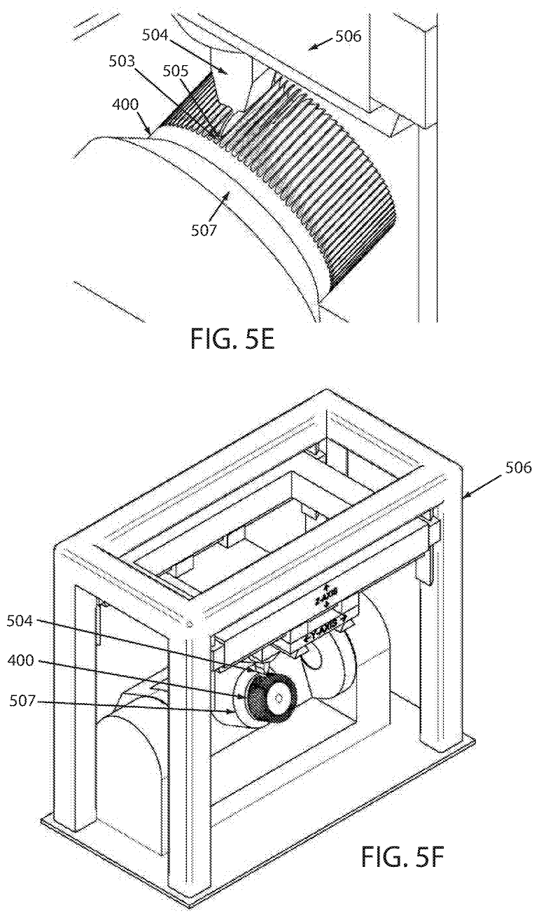

FIG. 3 is a diagram of the basic components and their arrangement for a gas turbine engine configured as a turboshaft engine driving a device for either power generation or transmission for propulsion. In this embodiment, the invention functions as a basic turboshaft engine 300 that consists of a compressor 301, a combustor 302, a primary turbine 303, a shaft 304 connecting the compressor to the primary turbine, a secondary turbine 305, and a secondary shaft 306 connecting the secondary turbine to a device 307 for power generation or transmission for propulsion. Like the jet engine embodiment 200, the hyper-feed machining feature of the invention enables the turboshaft engine 300 to be manufactured for small-scale applications for power generation and propulsion that are not possible or practical for current turboshaft engine designs.

FIG. 4A, FIG. 4B and FIG. 4C are an example of a small, complex blisk 400 employed as a high-efficiency compressor or turbine, the geometry of which permits only the use of hyper-feed machining 500, 501, 502, 503 for the rapid, precise production of its net shape 402. Illustrated are a plan view in 4A, an elevation view 4B and an isometric view in 4C. In addition to new applications for jet and turboshaft engines, the invention's embodiments of these types of gas turbine engines for current applications makes these engines much less expensive, quicker to manufacture, more flexible in materials used, reduced in mass, higher in performance, and more precise in shape and dimension because of the high-feed machining feature of the invention. In comparison, conventional machining (that is, by plastic deformation) of the blisk workpiece with a ball-nose end mill (ignoring the fact of the impracticality if not impossibility of a such a tool being capable of machining the entire surface of the blisk without cutting into the compound-curved blades) would be limited to a feed rate as little as one-thousandth of hyper-feed machining and take 160 hours or more to complete a rough, approximated net shape surface in contrast to the 10 minutes to net shape by hyper-feed machining.

Thus, the present invention's preferred embodiments described above are specifically the production of a blisk, a bladed ring, and other similar bladed components of a gas turbine engine using the invention's hyper-feed machining to induce the material removal phenomenon of controlled fracture. By removing material from the workpiece through the use of controlled fracture, as opposed to the plastic deformation of conventional milling, heat from the machining process is retained in the waste and not imparted to the workpiece. Therefore, thin and geometrically complex cross-sections can be machined without compromising the physical, structural, and dimensional integrity of the workpiece.

Hyper-feed machining significantly increases the ease of production and the geometric complexity of the bladed components of gas turbine engines while manufacturing them more closely to their ideal design. Hyper-feed machining also makes possible the manufacture of gas turbine engines, across the full scale of practical sizes. This is true in particular for small-scale gas turbine engines as described above, because current methods are relatively crude and cannot reproduce the ideal design of the geometric complexity of bladed components such as the compressor and turbine. Therefore, even the most advanced current methods of milling can only approximate the ideal design, assuming it is even possible or practical to use these methods, if the size of the gas turbine engine to be produced is sufficiently large to partially render the deviations from the design minor.

### The Preferred Embodiment of the Invention

Of the many new and useful embodiments of the invention, as described above, the currently best embodiment is the small-scale turboshaft electric engine for automotive vehicles, as illustrated in FIG. 3. This embodiment eliminates the need for both electric battery vehicles and piston-engine vehicles. Because of the invention, the current larger-scale turboshaft electric engine can be scaled down without loss of efficiency and a proportional retention of performance. For example, a conventional jet engine is about 60% efficient and produces 5,000 to 6,000 horsepower. The invention's new small-scale automotive turboshaft electric engine at about 10% of the size would also be 60% efficient and would produce about 500 to 600 horsepower. Also, the invention's capability for producing bladed components are greater in geometric complexity, more precise, and thinner in cross-section (thus lighter in weight) than is possible with current milling methods. This allows these small-scale turboshaft engines to “spool up” with reduced “turbo lag”.

In comparison to the current state-of-the-art electric automobiles, primarily the electric battery vehicle, the invention's turboshaft electric engine for automobiles eliminates “range anxiety”. Range anxiety is the concern that an electric battery vehicle driver has in finding a station to recharge the battery before it is depleted. This anxiety restricts the use of electric battery vehicles to mostly local use for recharging overnight at home. Out-of-town travel requires planning routes that will bring the electric battery vehicle to recharging stations within the automobile's range. Lacking a nationwide infrastructure of recharging stations that make them as common as gasoline stations, long-distance travel in an electric battery vehicle remains impractical. This is not so with the turboshaft electric automobile. The combustion chamber can use gasoline and many other types of fuel to ignite the compressed air flowing into the chamber. This makes the existing fueling infrastructure of gasoline stations sufficient for driving the invention's turboshaft electric automotive vehicles long distances.

Again in comparison to electric battery vehicles, the invention's turboshaft electric automobile completely eliminates the necessity of a battery (although there are practical uses for smaller internally rechargeable auxiliary batteries). The large, heavy, and expensive battery of an electric battery vehicle typically must be replaced before the life of the automobile is exhausted. Furthermore, these batteries are a source of environmental pollution, both in the mining and processing of the metals needed for them and their final disposal. Also, although the operation of an electric battery vehicle is not direct source of pollution, it must be recharged with electricity produced by power plants. Therefore, the electric battery vehicle merely shifts the source of pollution from vehicle to power plant. In contrast, the turboshaft electric automobile uses only a small amount of fuel for combustion, therefore producing only minor emissions. These fuels can be gasoline, compressed natural gas, propane, and other types of readily-available fossil fuels. For all these and other reasons, the small-scale turboshaft electric engine for use in automotive vehicles represents the best preferred embodiment of the invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of hyper-feed machining components for use in a turbomachine comprising the steps of:
providing a workpiece that is metal or a material of similar machining characteristics for use in the turbomachine;
driving a cutting tool into the workpiece using at least 20,000 lbs/sq-in of an impact induced force to produce controlled fracturing which exceeds both the yield strength and the breaking strength of the workpiece material by an impact force which causes the axial projection of adiabatic shear banding of the workpiece material along the perimeter of the cutting tool; and
removing desired amounts of material from the workpiece at precise locations to create both a disk and a plurality of blades without plastic deformation;
shaping the workpiece into a turbomachine component at a rate to provide a substantially significant cost savings in production as compared to milling.

2. A method of hyper-feed machining as in claim 1, wherein the workpiece is shaped into a blisk.

3. A process of manufacturing a turbomachine component using hyper-feed machining comprising the steps of:
fixturing a workpiece to a table;
positioning a face of a cutting tool substantially perpendicular to a surface of the workpiece;
approaching the surface of the workpiece with the cutting tool to a predetermined clearance level;
driving the cutting tool into the workpiece through the use of controlled fracturing by simultaneously exceeding the yield strength and the breaking strength of the workpiece material so to prevent plastic deformation by an impact which causes the axial projection of adiabatic banding along the circumference of the tool to remove desired amounts of workpiece material without plastic deformation;
creating shear bands in the workpiece that emanate from the face of the cutting tool using the forces provided by the cutting tool to shape the workpiece into the turbomachine component;
removing material from the workpiece at a substantially rapid feed to increase the rate of volumetric material removal to at least an order of magnitude higher than that provided by milling processes;
withdrawing the cutting tool from the workpiece to a predetermined level; and
repeating the step of driving an asymmetrical cutting tool through the workpiece to form the turbomachine component having a greater geometrical complexity than that possible using milling processes.

4. The process of manufacturing as in claim 3, further comprising the step of:
providing a force of at least 20,000 lbs/sq-in to remove predetermined amounts of workpiece material having a desired size and shape to form the blades of a turbomachine blisk.

5. A method of hyper-feed machining a bladed component for use in a turbomachine comprising the steps of:
fixturing workpiece that is metal or a material of similar machining characteristics to a table of the multi-axis machine tool;
adjusting the cutting face of a machine tool by rotating the cutting tool or workpiece so that an optimal cutting force can be achieved;
approaching the surface of the workpiece with the cutting tool to a level sufficient to clear obstructions and to allow acceleration of the cutting tool to the feed required for controlled fracturing;
driving the cutting tool without rotation about its axis into the workpiece using a force of at least 20,000 lbs/sq-in through the use of controlled fracturing by simultaneously exceeding the yield strength and the breaking strength of the workpiece material by an impact to cause the axial projection of adiabatic banding along the perimeter of the tool;
removing desired workpiece material at a substantially fast feed to form at least one blade that conforms to the perimeter of the cutting face of the cutting tool such that both volumetric material removal of the workpiece and the geometrical complexity of the at least one blade is greater than that possible by milling; and
shaping the workpiece into a turbomachine blade for use in a blisk at a rate to provide a substantially significant cost savings in production as compared to milling.

6. A method of hyper-feed machining blisk as in claim 5, further comprising the step of:
forming the blisk for use in a substantially small scale gas turbine engine.
